(19) United States
(12) Patent Application Publication
(10) Pub. No.: US 2008/0255366 A1
(43) Pub. Date: Oct. 16, 2008

(54) Crystalline Trihydrate of Zoledronic Acid

(75) Inventors: Pradeep Kumar Mohakhud, Hyderabad (IN); Veerender Murki, Secunderabad (IN); Kishore Babu Nandamudi, Hyderabad (IN); Moses Babu, Secunderabad (IN); Surajit Banerjee, Hyderabad (IN)

Correspondence Address: DR. REDDY'S LABORATORIES, INC., 200 SOMERSET CORPORATE BLVD, SEVENTH FLOOR,, BRIDGEWATER, NJ, 08807-2862, US

(73) Assignees: DR. REDDY'S LABORATORIES LIMITED, Hyderabad, Andhra Pradesh (IN); DR. REDDY'S LABORATORIES, INC., Bridgewater, NJ (US)

(21) Appl. No.: 12/066,294

(22) PCT Filed: Jul. 6, 2006
(86) PCT No.: PCT/US06/26153

§ 371 Date: Mar. 10, 2008

(30) Foreign Application Priority Data
Sep. 12, 2005 (IN) 1268/CHE/2005

(51) Int. Cl. C07F 9/6506

(52) U.S. Cl. 548/112

(57) ABSTRACT

Zoledronic acid trihydrate, processes for its preparation, and conversion into zoledronic acid monohydrate.

### INTRODUCTION TO THE INVENTION

The present invention relates to a crystalline zoledronic acid trihydrate and a process for the preparation thereof.

The chemical name of zoledronic acid is (1-Hydroxy-2-imidazol-1-yl-phosphonoethyl) phosphonic acid and the compound can be structurally represented by Formula I.

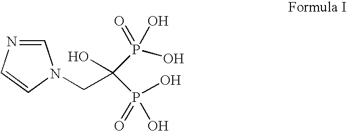

Zoledronic acid is a third generation bisphosphonate derivative characterized by a side chain that includes an imidazole ring. It inhibits osteoclast bone resorption and is used for the treatment of tumor-induced hypercalcemia. It is commercially available in products sold under the brand name ZOMETA™ in vials as a sterile powder or solution for intravenous infusion. Each vial contains 4 mg of zoledronic acid (anhydrous), corresponding to 4.264 mg of zoledronic acid monohydrate.

Chemical synthesis of zoledronic acid has to date been directed to the preparation of the monohydrate substance. U.S. Pat. No. 4,939,130 discloses zoledronic acid and, in Example 10, a process for making zoledronic acid as shown in Scheme 1.

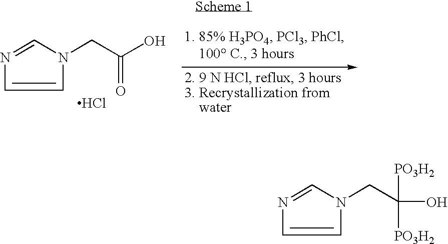

Briefly, the process comprises reacting 2-(1-imidazolyl) acetic acid hydrochloride with phosphoric acid in the presence of phosphorous trichloride and hydrochloric acid to yield zoledronic acid, which is precipitated by dilution with acetone. The crude zoledronic acid thus obtained is recrystallized in water. The final step of recrystallization of the crude substance from water provides the monohydrate of zoledronic acid.

PCT Application Publication No. WO 2005/063717 also involves a similar recrystallization from water in the final step providing the monohydrate compound of zoledronic acid.

PCT Application Publication No. WO 2005/005447 discloses various crystalline forms of zoledronic acid, and its sodium salts and processes for preparation thereof. It describes the preparation of crystalline Forms I, II, XII, and XVIII, which are monohydrates of zoledronic acid, and Forms XV, XX, and XXVI, which are anhydrous forms of zoledronic acid. It also describes various hydrated and anhydrous forms of the monosodium and disodium salts of zoledronic acid, and also describes amorphous zoledronate monosodium, disodium and trisodium salts.

Although a considerable amount of work has been done on the polymorphic characterization of zoledronic acid, there remains a need to identify other forms that can be generated.

Among the patents described above, two patents describe the preparation of monohydrate, but none of them give the complete details of the process. U.S. Pat. No. 4,939,130 simply says in Example 1, that the product is recrystallized in water, but does not give the conditions for recrystallization. International Application Publication No. WO 2005/063717 exemplifies a process for the preparation of monohydrate involving recrystallization of crude zoledronic acid in water by dissolving the crude in water at 90 to 95° C. for 2 to 3 hours followed by a carbon treatment in hot condition, and then cooling the reaction mass to 25 to 35° C. for crystallization.

Both the patents do not give the critical parameters for the formation of monohydrate during recrystallization from water. During scale up of the batches for the production of monohydrate by following the above process, frequently there has been observed a contamination with other crystalline forms.

Regulatory authorities throughout the world require that all possible crystalline forms of the same active compound be synthesized and characterized as completely as possible. It is also required that the commercial product should not contain traces of any of the other forms or, if present, the percentages of each of the forms be well characterized to avoid changes in the dissolution and bioavailability characteristics of drug substance during storage.

There is thus a continuing need to prepare new polymorphic forms of pharmacologically active compounds of commercial interest such as zoledronic acid, which provide the pharmaceutical formulation scientist with a broader spectrum of crystalline forms of an active ingredient to choose from, based on their differing physiochemical properties.

It is also important that the processes for the preparation of the polymorphic forms be robust and reproducible, so that the processes are easily scaled up in the plant. Thus, improvements are needed in zoledronic acid production.

### SUMMARY OF THE INVENTION

The present invention relates to a crystalline trihydrate of zoledronic acid and a robust and reproducible process for its preparation.

One aspect of the invention provides a crystalline trihydrate of zoledronic acid characterized by its single crystal X-ray diffractogram (XRD), X-ray powder diffraction (XRPD) pattern, infrared (IR) absorption spectrum, differential scanning calorimetry (DSC) curve, and thermogravimetric analysis (TGA) curve.

In another aspect, the present invention provides a robust and reproducible process for the preparation of the crystalline trihydrate of zoledronic acid.

In an embodiment, the process for the preparation of crystalline trihydrate of zoledronic acid comprises;

a) providing a solution of zoledronic acid;

b) crystallizing the solid from the solution; and

c) recovering the separated zoledronic acid trihydrate crystals.

Yet another aspect of the invention provides a process for the conversion of a mixture of zoledronic acid monohydrate and zoledronic acid trihydrate to zoledronic acid monohydrate.

Still another aspect of the invention provides a process for the preparation of zoledronic acid monohydrate from zoledronic acid trihydrate.

A further aspect of the invention provides crystalline zoledronic acid trihydrate having solubility substantially equal to that of the monohydrate.

A still further aspect of the invention provides crystalline zoledronic acid trihydrate having a particle size of less than about 300 μm.

Zoledronic acid trihydrate can be characterized by its XRPD pattern, substantially in accordance with FIG. 1.

Zoledronic acid trihydrate can also be characterized by its IR spectrum, substantially in accordance with FIG. 2.

Zoledronic acid trihydrate can also be characterized by its DSC curve, substantially in accordance with FIG. 3.

In an embodiment, a process for preparing zoledronic acid trihydrate comprises providing a solution of zoledronic acid in a solvent comprising water at temperatures of about 60 to 80° C., and cooling the solution to crystallize zoledronic acid trihydrate.

In another embodiment, a process for converting zoledronic acid trihydrate to zoledronic acid monohydrate comprises drying zoledronic acid trihydrate at temperatures about 40 to 90° C.

In a further embodiment, a process for converting zoledronic acid trihydrate to zoledronic acid monohydrate comprises forming a slurry of zoledronic acid trihydrate in a ketone.

In a still further embodiment, a process for preparing zoledronic acid monohydrate comprises providing an aqueous solution of zoledronic acid and adding an antisolvent for zoledronic acid.

In a yet further aspect, the present invention provides a pharmaceutical composition comprising zoledronic acid trihydrate along with one or more pharmaceutically acceptable carriers, excipients, or diluents.

### BRIEF DESCRIPTION OF THE DRAWINGS

FIG. 1 is an XRPD pattern of a crystalline trihydrate of zoledronic acid prepared in Example 1.

FIG. 2 is an IR spectrum of a crystalline trihydrate of zoledronic acid prepared in Example 1.

FIG. 3 is a DSC curve of a crystalline trihydrate of zoledronic acid prepared in Example 1.

FIG. 4 is the single crystal structure of zoledronic acid trihydrate prepared in Example 1.

FIG. 5 is a simulated XRD pattern from the single crystal data for a crystalline trihydrate of zoledronic acid prepared in Example 1.

FIG. 6 is a TGA curve of crystalline zoledronic acid trihydrate, superimposed on the DSC curve for the compound prepared in Example 1.

### DETAILED DESCRIPTION OF THE INVENTION

An aspect of the invention involves a crystalline trihydrate of zoledronic acid.

The crystalline trihydrate of zoledronic acid is characterized by any of its X-ray powder diffraction (“XRPD”) pattern, single crystal X-ray diffraction (“XRD”) parameters, infrared absorption (“IR”) spectrum, differential scanning calorimetry (“DSC”) curve, and thermogravimetric analysis (“TGA”) curve.

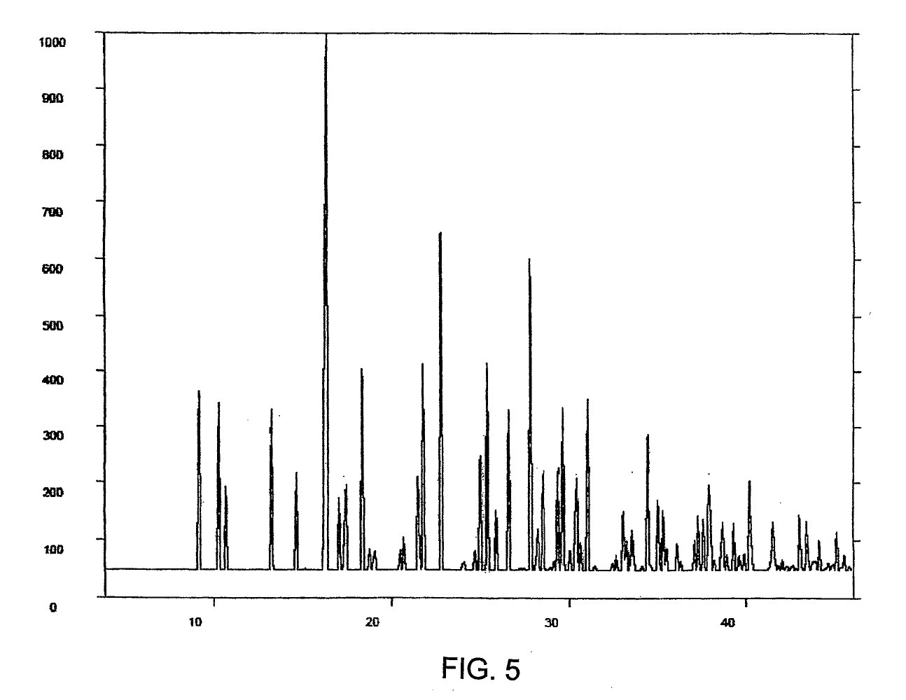

Single crystal X-ray diffraction data were collected on a Rigaku Mercury CCD area detector with graphite monochromatic Mo—Kα radiation. The structure was solved by direct methods and (SIR92) and refined by the least squares method. The present R factor is 0.038 and Rw=0.039 for 2110 observed reflection. The simulated powder diffraction pattern from single crystal data is shown in FIG. 5.

Zoledronic acid trihydrate is characterized by its XRPD pattern, which shows differences from the previously known forms. The XRPD data reported herein were obtained using Cu Kα-1 radiation, having the wavelength 1.541 Å, and were measured on a Bruker Axe, D8 Advance Powder X-ray Diffractometer.

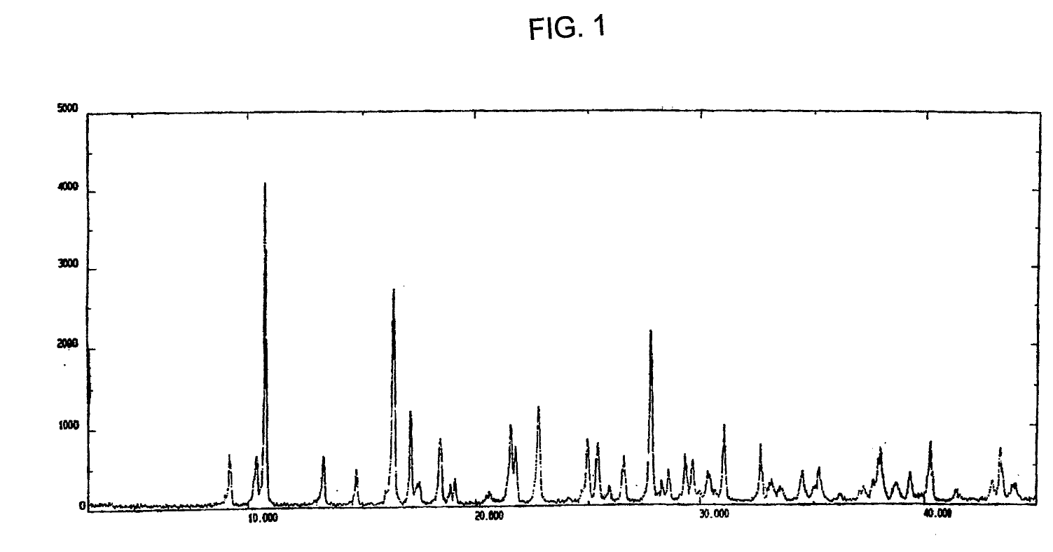

The crystalline trihydrate of zoledronic acid is characterized by its XRPD pattern substantially in accordance with the pattern of FIG. 1. The crystalline trihydrate of zoledronic acid is also characterized by an XRPD pattern having significant peaks at about 10.8, 16.4, 17.1, 18.4, 21.6, 24.9, 25.4, 27.8, 31.0, and 32.6, +0.2 degrees 2θ. It is also characterized by the additional XRPD peaks at about 38.0, 40.2, 21.8, 9.2, 10.3, and 43.4, ±0.2 degrees 2θ.

Zoledronic acid trihydrate is also characterized by its crystal structure for which the lattice parameters were determined by single-crystal X-ray diffraction.

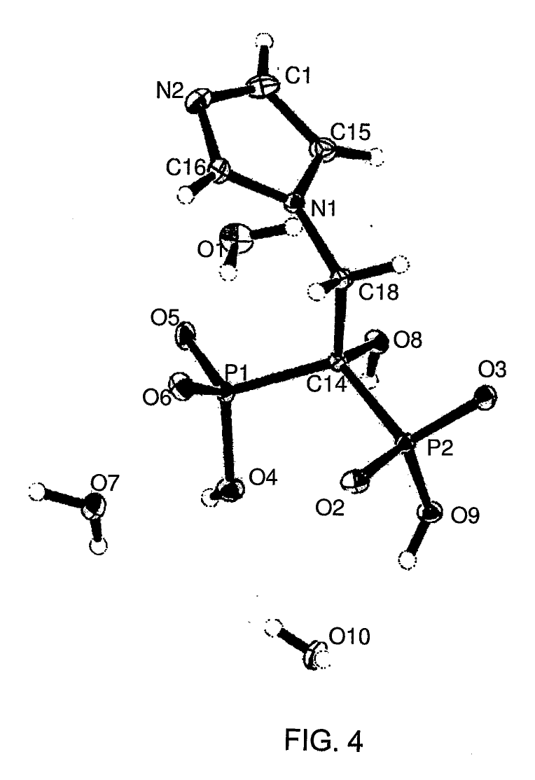

The crystal structure of zoledronic acid trihydrate is shown in FIG. 4. The trihydrate crystallizes in the triclinic space group P1 with the unit cell parameters as given in Table 1.

TABLE 1
Space group and unit cell parameters
for zoledronic acid trihydrate.

| Parameter space group | Trihydrate | |
|---|---|---|
| Cell dimensions | P2₁/c (No. 14) | |
| 1a (Å) | 6.863 | (2) |
| b (Å) | 9.439 | (3) |
| c (Å) | 10.808 | (3) |
| α (Å) | 65.175 | (7) |
| β (Å) | 76.816 | (11) |
| γ (Å) | 81.386 | (13) |
| Volume (Å³) | 617.6 | (3) |

| | |
|---|---|
| Z (Molecules/Unit cell) | 2 |

The packing in three dimensions is stabilized by strong intra- and inter-molecular hydrogen bonding as given in Table 2.

TABLE 2
Hydrogen bond parameters.

| D-H . . . A | D-H . . . (Å) | H-A . . . (Å) | D-A . . . (Å) | D-H . . . A (°) | Symmetry codes |
|---|---|---|---|---|---|
| O1-H4 . . . O10 | 0.7900 | 2.0300 | 2.795(3) | 165.00 | 2 − x, 2 − y, −z |
| O9-H6 . . . O3 | 0.8100 | 1.8900 | 2.692(3) | 168.00 | 1 − x, 2 − y, 1 − z |
| O8-H8 . . . O6 | 0.9100 | 1.7000 | 2.611(3) | 178.00 | 2 − x, 1 − y, 1 − z |
| O9-H9 . . . O2 | 0.7600 | 1.9800 | 2.724(3) | 170.00 | 1 + x, y, z |
| O10-H10 . . . O2 | 0.8500 | 1.9500 | 2.783(3) | 167.00 | x, y, z |
| O10-H11 . . . 02 | 0.9100 | 2.4400 | 3.254(3) | 150.00 | 1 − x, 2 − y, −z |
| O8-H12 - - - O9 | 0.7500 | 1.8300 | 2.575(3) | 173.00 | 2 − x, 2 − y, −z |
| O4-H13 . . . O3 | 0.8100 | 1.7900 | 2.599(3) | 175.00 | 1 − x, 2 − y, 1 − z |
| O7-H14 . . . O2 | 0.8100 | 1.8000 | 2.583(2) | 165.00 | 1 + x, y, z |

From the single-crystal information for crystalline zoledronic acid trihydrate, a simulated powder diffractogram (theoretical diffractogram) was obtained which was comparable to that obtained experimentally. The very high similarity observed between the theoretical and experimental diffractograms indicates that the structure contained in the powder corresponds to that determined in the single-crystal and that this structure is unique, that is to say that there are not other polymorphic forms mixed with the crystalline trihydrate of zoledronic acid.

The infrared spectra of the crystalline trihydrate of zoledronic acid has been recorded on Perkin Elmer System 200 FT-IR spectrophotometers, between 400 cm⁻¹ and 4000 cm⁻¹, with a resolution of 4 cm⁻¹, in a potassium bromide pellet where the test compound is at a concentration of 0.5% by mass.

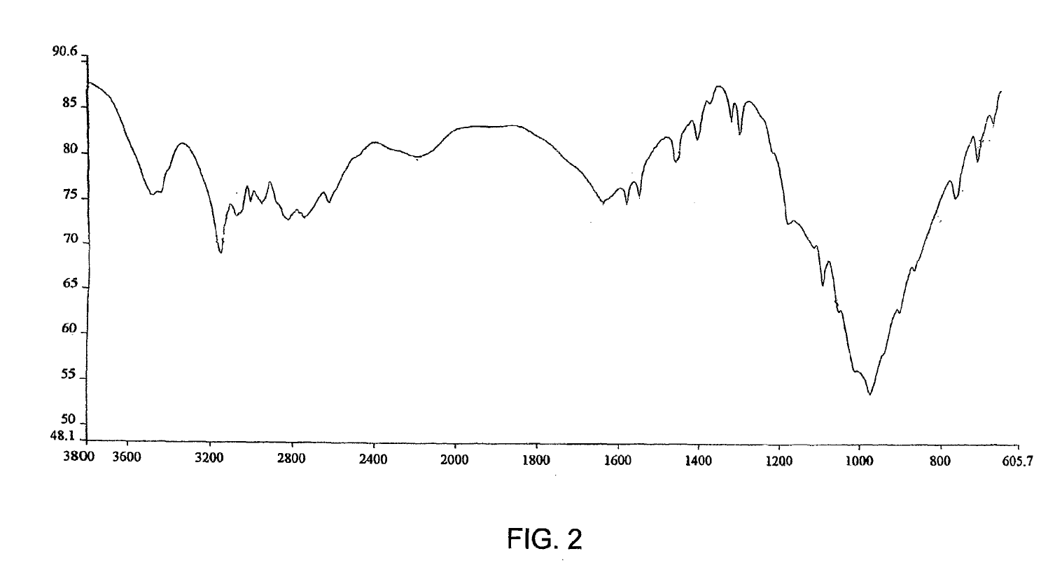

The crystalline trihydrate of zoledronic acid is further characterized by an infrared absorption spectrum comprising peaks at about 671, 712, 766, 975, 1301, 1323, 1406, 1460, 1550, 2826, 3154, and 3484, +5 cm⁻¹. The crystalline trihydrate of zoledronic acid trihydrate is also characterized by its infrared absorption spectrum substantially in accordance with the spectrum of FIG. 2.

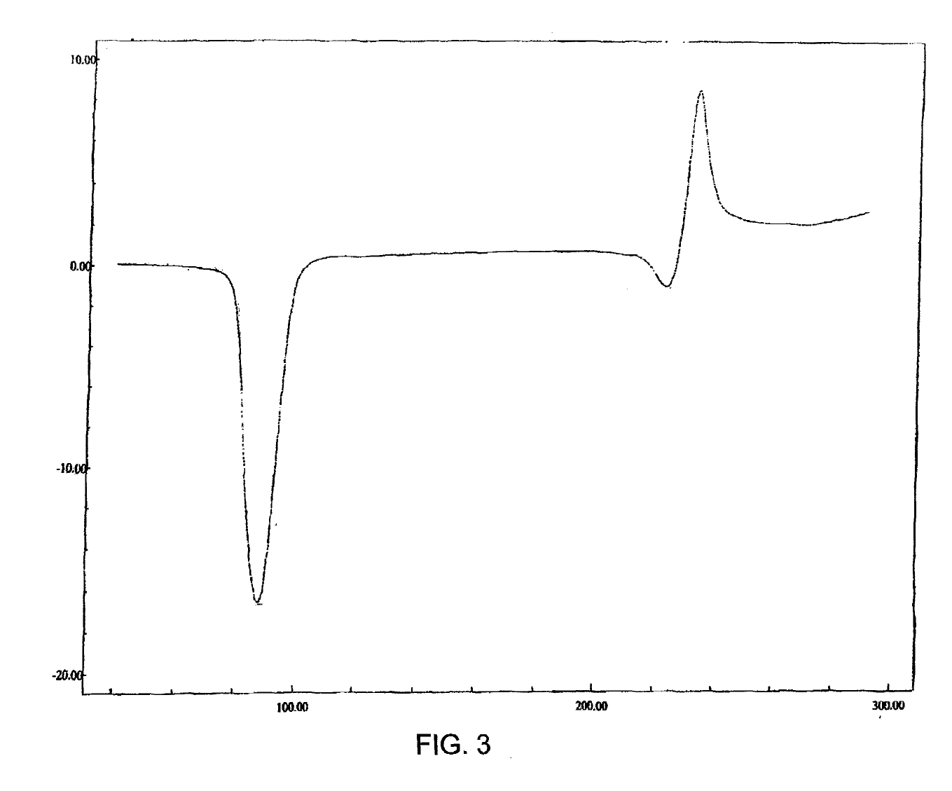

The crystalline trihydrate of zoledronic acid is also further characterized by a differential scanning calorimetry curve substantially in accordance with the curve of FIG. 3. The crystalline trihydrate of zoledronic acid is also characterized by a DSC curve having an exotherm at about 234° C., and endotherms at about 224° C. and about 88° C.

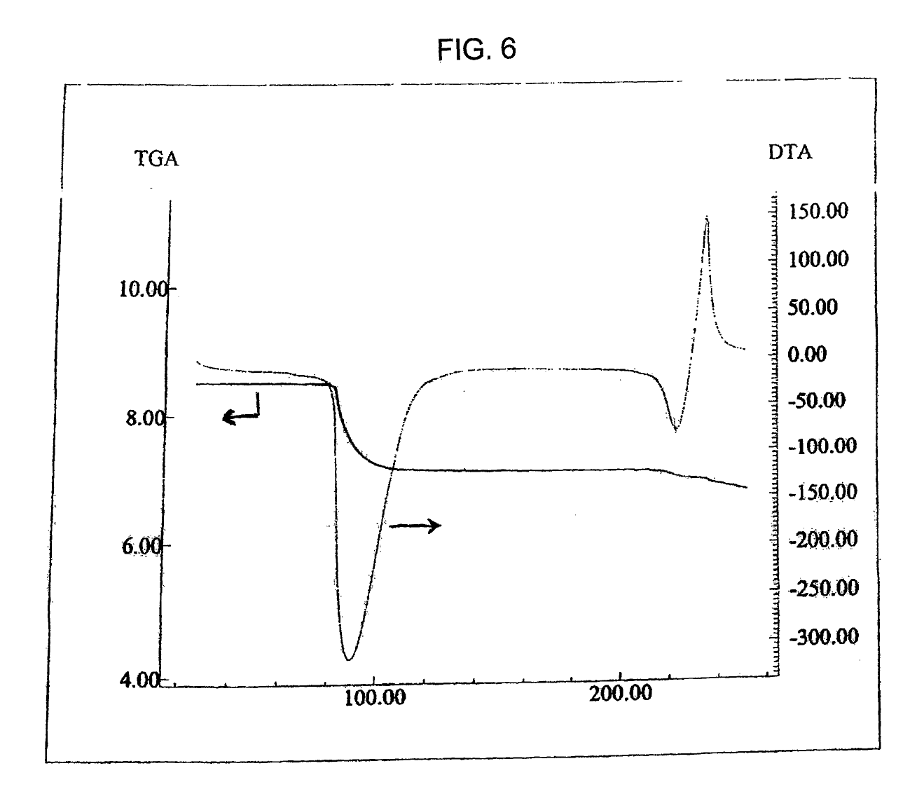

The crystalline trihydrate of zoledronic acid is still further characterized by a thermogravimetric analysis curve substantially in accordance with the DTA curve of FIG. 6, showing the loss of three molecules of water. In FIG. 6, the left vertical axis is milligrams of sample, the right vertical axis is millivolts from a thermocouple, and the horizontal axis is temperature in ° C.

The moisture content of zoledronic acid can range from 15 to 18% by weight.

In another aspect, the present invention provides a robust and reproducible process for the preparation of the crystalline trihydrate of zoledronic acid.

In an embodiment, a process for the preparation of the trihydrate comprises:

a) providing a solution of zoledronic acid;

b) crystallizing the solid from the solution; and

c) recovering the separated zoledronic acid trihydrate crystals.

Step a) Involves Providing a Solution of Zoledronic Acid.

The solution of zoledronic acid may be obtained by dissolving the zoledronic acid in a suitable solvent, or such a solution may be obtained directly from a reaction in which zoledronic acid is formed.

When the solution is prepared by dissolving zoledronic acid in a suitable solvent, any form of zoledronic acid such as the crystalline or amorphous form, including any salts, solvates and hydrates may be utilized for preparing the solution.

Suitable solvents useful in the preparation of the trihydrate of zoledronic acid include water alone or in combination with an organic solvent, such as for example alcohols such as methanol, ethanol, propanol, tertiary butanol, n-butanol; ketones like acetone, propanone; acetonitrile, dimethylformamide, dimethylsulphoxide, dioxane, and the like; and mixtures thereof.

In a related embodiment, the invention involves heating a solution of zoledronic acid in the solvent or mixture of solvents to a temperature of about ambient temperature to about 80° C., or about 60 to 80° C., or about 70 to 75° C., to get a clear solution. For the preparation of zoledronic acid trihydrate solutions, any temperature below about 80° C. may be used as long as a clear solution is obtained. The higher temperatures in these ranges will provide higher concentrations of solute, and generally result in greater process efficiency.

The maximum temperature used for the dissolution of zoledronic acid is important as it determines the resulting polymorphic form of zoledronic acid. When the solution is heated to temperatures above about 90° C., it results in crystalline monohydrate and heating the solution to lower temperatures, such as in the range of about 40 to 80° C., or about 70 to 75° C., results in the crystalline trihydrate of zoledronic acid.

The solution can be maintained at this temperature for about 1 minute to any desired time. If the mixture is heated to about 75° C., the minimum required maintenance time at the elevated temperature, before cooling commences, is negligible.

The solution can optionally be filtered by passing through paper, glass fiber, or other membrane material or a clarifying agent such as celite. Depending upon the equipment used and the concentration and temperature of the solution, the filtration apparatus may need to be preheated to avoid premature crystallization.

The concentration of the solute can be about 0.1 g/ml to about 20 g/ml in the solvent, or it can range form 1 g/ml to 5 g/ml.

Step b) Involves Crystallizing the Solid from the Filtrate.

Crystallization is usually done at temperatures lower than the dissolution temperature. The temperatures for crystallization may be below about 40° C. or below 30° C.

The crystallization may be performed with stirring until the desired crystal yield has been obtained, such as for about one hour to about 72 hours. The crystallization step may further include facilitative measures known to one skilled in the art. For example, crystallization step may further include cooling the solution, heating the solution, or adding an agent to induce precipitation.

The temperature of the solution may be brought down for crystallization to occur either rapidly using external cooling, or it may be allowed to cool to the isolation temperature on its own. Generally, for large scale batches on the order of 1 to 5 kg or more, if the reaction mass is allowed to cool on its own, it may take an inconvenient amount of time, hence, external cooling is frequently provided to the reaction mass to bring down its temperature to the required level.

There is no disadvantage to further extending the cooling period, other than an increased processing expense, and an appropriate time for a given batch size can be determined with little effort by one skilled in the art. The cooling of the solution may be achieved by simple radiation cooling under atmospheric conditions, accompanied by stirring, or through the use of controlled cooling mechanisms such as for example circulation of cooling media in jacket vessels and the like. Such techniques for rapid and gradual cooling are well known to a person skilled in the art and are all included herein without limitation.

When compared to the process for preparation of crystalline monohydrate of zoledronic acid which involves the dissolution of zoledronic acid in the solvent at higher temperatures of 90 to 95° C., followed by isolation of the solid at lower temperatures, the process for the trihydrate is robust and reproducible. The monohydrate preparation is dependant on variables like the rate of cooling of the solution of zoledronic acid during isolation and maintenance temperature of the solution during dissolution etc.

Improper maintenance of the solution of zoledronic acid above 90 to 95° C. during the dissolution may result in a mixture of monohydrate and trihydrate. Also, if the reaction mass is cooled rapidly from the dissolution temperature to the crystallization temperature, the result is a mixture of monohydrate and trihydrate of zoledronic acid.

Many processing measures need to be taken during the large scale preparation of monohydrate.

Step c) Involves Recovery of the Isolated Zoledronic Acid Trihydrate Crystals.

Recovery can be performed by any means including, but not limited to, filtration, centrifugation, and decanting. The crystalline form may be recovered from any composition containing the crystalline form and the solvent or solvents including but not limited to a suspension, solution, slurry, and emulsion.

The obtained compound can be further dried under ambient or reduced pressure. For example, drying can be performed under reduced pressure or under atmospheric pressure at a temperature of at about 40° C. to 60° C., or 70° C. to 80° C., or higher. Drying can be performed until a desired residual solvent content has been obtained, such as for a duration of about 2 hours to 24 hours, or about 3 to 6 hours.

Yet another aspect of the invention provides a process for the conversion of a mixture of zoledronic acid monohydrate and trihydrate to zoledronic acid monohydrate.

As is known, the process for the preparation of zoledronic acid monohydrate is not robust, and during large scale production, if the critical parameters are not used, there are chances of getting a mixture of zoledronic acid monohydrate and trihydrate.

The present invention provides a process for the conversion of the mixture of trihydrate and monohydrate into zoledronic acid monohydrate.

In an embodiment, a process for the conversion of a mixture of zoledronic acid monohydrate and trihydrate into zoledronic acid monohydrate involves any one of the processes of extended drying of the material comprising trihydrate at temperatures higher than 50° C. under vacuum, or by forming a slurry comprising the trihydrate material in an organic solvent.

The temperatures for drying may range from 40 to 90° C., or 60 to 70° C., or 55 to 60° C., and the compound may be dried under ambient or reduced pressure. For example, drying can be performed under reduced pressure or under atmospheric pressure in any one of an air oven, vacuum oven, or tray drying and the like can be used. Optionally, drying can be conducted under an inert atmosphere.

Suitable solvents which can be used for slurrying the trihydrate are ketones like acetone, ethyl methyl ketone, propanone, and the like.

The slurrying may be accompanied by stirring, and it may be carried out for a period of about 1 hour to about 10 hours or more.

Any amount of solvent ranging from about 5 to 100 times may be taken for the purpose of forming the slurry.

A further aspect of the invention involves the conversion of zoledronic acid trihydrate to zoledronic acid monohydrate.

In another embodiment, a process for the conversion of zoledronic acid trihydrate to zoledronic acid monohydrate involves recrystallization by a solvent-antisolvent technique. The process comprises providing zoledronic acid and a suitable solvent, and heating the mixture to provide a clear solution followed by addition of an antisolvent to obtain a precipitate of the required product.

Suitable solvents that can be used for dissolution include for example: water; alcohols such as methanol, ethanol, propanol, n-butanol; dimethylformamide; dimethylsulphoxide; tetrahydrofuran; and the like; and mixtures thereof.

Antisolvents which can be used include for example: hydrocarbons such as n-hexane, n-heptane, and toluene; ketones such as acetone, propanone, ethyl methyl ketone, and butanone; ethers such as diethyl ether, isopropyl ether, etc; esters such as ethyl acetate, tertiary butyl acetate and the like; halogenated hydrocarbons such as dichloromethane, 1,2-dichloroethane, chloroform, carbon tetrachloride; and mixtures thereof.

The dissolution procedure can be carried out at elevated temperatures ranging from about 95 to 120° C. Heating may be accompanied by stirring or agitation continuously or occasionally by any means including but not limited to mechanical and magnetic means. The amount of solvent should be sufficient to dissolve the zoledronic acid to form a concentrated solution.

Addition of anti-solvent to the solution of the zoledronic acid may be carried out at temperatures of about 0 to 120° C., or 60 to 90° C., or at ambient temperatures, or at lower temperatures ranging from about 0 to 15° C.

Recovery of the isolated solid can be performed by any means including but not limited to filtration, centrifugation, and decanting. The crystalline form may be recovered from any composition containing the crystalline form and the solvent or solvents including but not limited to a suspension, solution, slurry, and emulsion.

The obtained compound can be further dried under ambient or reduced pressure. For example, drying can be performed under reduced pressure or under atmospheric pressure at a temperature of at about 40° C. to 60° C., or 70° C. to 80° C., or higher. Drying can be performed for a duration of up to about 2 hours, or up to about 5 hours or more, depending on the drying conditions used and the amount of residual solvent content that is acceptable.

Thus, the invention provides a reproducible process for preparing pure zoledronic acid trihydrate, which can be used to manufacture pharmaceutical products. However, if desired, the zoledronic acid trihydrate can easily be converted to pure zoledronic acid monohydrate and used to manufacture pharmaceutical products. An advantage of the present invention is providing the ability to predictably prepare a desired pure form of zoledronic acid.

Still another aspect of the invention provides crystalline zoledronic acid trihydrate having a solubility substantially equal to that of the monohydrate. The solubility of zoledronic acid is comparable with that of the monohydrate of zoledronic acid. This facilitates the use of zoledronic acid trihydrate in pharmaceutical compositions.

A still further aspect of the invention provides crystalline zoledronic acid trihydrate having a particle size of less than 300 μm.

The D₁₀, D₅₀ and D₉₀ values are useful ways for indicating a particle size distribution. D₉₀ refers to the value for the particle size for which at least 90 volume percent of the particles have a size smaller than the said value. Likewise D₅₀ and D₁₀ refer to the values for the particle size for which 50 volume percent, and 10 volume percent of the particles have a size smaller than the said value. A D₅₀ value can be considered as being the mean particle size of a powder. Methods for determining D₁₀, D₅₀ and D₉₀ include laser diffraction using Malvern equipment.

Crystalline zoledronic acid trihydrate according to the invention has a D₁₀ less than 10 μm or less than 20 μm, D₅₀ less than 100 μm or less than 150 μm, and D₉₀ less than 200 μm or less than 300 μm. There is no specific lower limit for any of the D values.

In a yet further aspect, the present invention provides a pharmaceutical composition comprising zoledronic acid trihydrate along with one or more pharmaceutically acceptable carriers, excipients, or diluents.

The pharmaceutical composition comprising zoledronic acid trihydrate along with one or more pharmaceutically acceptable carriers of this invention may further be formulated as: solid oral dosage forms such as, but not limited to, powders, granules, pellets, tablets, and capsules; liquid oral dosage forms such as but not limited to syrups, suspensions, dispersions, and emulsions; and injectable preparations such as but not limited to solutions, dispersions, and freeze dried compositions. Formulations may be in the form of immediate release, delayed release or modified release. Further, immediate release compositions may be conventional, dispersible, chewable, mouth dissolving, or flash melt preparations, and modified release compositions that may comprise hydrophilic or hydrophobic, or combinations of hydrophilic and hydrophobic, release rate controlling substances to form matrix or reservoir or combination of matrix and reservoir systems. The compositions may be prepared by direct blending, dry granulation or wet granulation or by extrusion and spheronization. Compositions may be presented as uncoated, film coated, sugar coated, powder coated, enteric coated or modified release coated. Compositions of the present invention may further comprise one or more pharmaceutically acceptable excipients.

Pharmaceutically acceptable excipients that find use in the present invention include, but are not limited to: diluents such as starch, pregelatinized starch, lactose, powdered cellulose, microcrystalline cellulose, dicalcium phosphate, tricalcium phosphate, mannitol, sorbitol, sugar and the like; binders such as acacia, guar gum, tragacanth, gelatin, polyvinyl pyrrolidone, hydroxypropyl cellulose, hydroxypropyl methylcellulose, pregelatinized starch and the like; disintegrants such as starch, sodium starch glycolate, pregelatinized starch, crospovidone, croscarmellose sodium, colloidal silicon dioxide and the like; lubricants such as stearic acid, magnesium stearate, zinc stearate and the like; glidants such as colloidal silicon dioxide and the like; solubility or wetting enhancers such as anionic or cationic or neutral surfactants; complex forming agents such as various grades of cyclodextrins, resins; release rate controlling agents such as hydroxypropyl cellulose, hydroxymethyl cellulose, hydroxypropyl methylcellulose, ethyl cellulose, methyl cellulose, various grades of methyl methacrylates, waxes and the like. Other pharmaceutically acceptable excipients that are of use include but are not limited to film formers, plasticizers, colorants, flavoring agents, sweeteners, viscosity enhancers, preservatives, antioxidants and the like.

In the compositions of the present invention zoledronic acid trihydrate is a useful active ingredient in the range of 0.5 mg to 50 mg, or 1 mg to 25 mg.

Certain specific aspects and embodiments of this invention are described in further detail by the examples below, which examples are not intended to limit the scope of the appended claims in any manner.

### EXAMPLE 1

### Preparation of Zoledronic Acid Trihydrate

5 g of anhydrous zoledronic acid was taken into a round bottomed flask equipped with a magnetic stirrer, condenser and oil bath, then 150 ml of water was added to it. The reaction mass was heated slowly to 73° C. to obtain a clear solution. The solution was filtered while hot to make it particle free. The clear filtrate was taken into a fresh round-bottomed flask and allowed to cool to 30° C. The reaction mass was stirred at 30° C. for 10 minutes. The separated solid was filtered under vacuum. The compound was suction dried under a vacuum of 600 mm Hg for 10 minutes to get 3.6 g of the title compound.

Samples of this product were analyzed, to generate all of FIGS. 1-6.

Moisture content: 15.5% (w/w) by the Karl Fischer method.

Melting point: 238±3° C.

### EXAMPLE 2

### Conversion of Mixture of Trihydrate and Monohydrate to Monohydrate by Drying

1 g of zoledronic acid trihydrate was taken in a clean Petri dish. The compound was then dried in a vacuum oven at 60° C. under a vacuum of 600 mm Hg for 16 hours to obtain zoledronic acid monohydrate.

### EXAMPLE 3

### Conversion of a Mixture of Monohydrate and Trihydrate to Monohydrate by Slurrying

5 ml of acetone was placed into a round bottom flask along with 0.5 g of zoledronic acid trihydrate. The mixture was then stirred at 28° C. for 30 minutes. The mixture was filtered under a vacuum of 600 mm Hg and the solid was finally dried under vacuum at 28° C. to give the monohydrate of zoledronic acid.

### EXAMPLE 4

### Conversion of Trihydrate to Monohydrate Using Solvent-Antisolvent Technique

30 ml of water was placed into a round bottomed flask along with 1 g of zoledronic acid trihydrate. The mixture was stirred for about 10 to 20 minutes at 28° C. followed by heating to 99° C. and was maintained at 99° C. for another 15 minutes. The mass was then allowed to cool by radiation to 67° C. At this temperature 10 ml of methanol was added to precipitate the product, and the mass was then stirred until it had cooled to 28° C. The separated solid was filtered under vacuum and was washed with 10 ml of water. The solid was than suction dried under a vacuum of 600 mm Hg for 30 minutes at 28° C. and finally dried at 59° C. under a vacuum of 600 mm Hg for 12 hours to afford the crystalline monohydrate of zoledronic acid.

### EXAMPLE 5

### Conversion of Trihydrate to Monohydrate Using Solvent-Antisolvent Technique

30 ml of water was placed into a round bottom flask along with 1 g of zoledronic acid trihydrate. The mixture was stirred for about 10 minutes at 28° C. followed by heating to 99° C. and was maintained at 99° C. for another 30 minutes. The mixture was then allowed to cool by radiation to 57° C. At this temperature, 10 ml of acetone was added to precipitate the product. The mixture was then stirred until it had cooled to 28° C. The mass was maintained at 28° C. for 3 hours. The separated solid was then filtered under a vacuum of 600 mm Hg. The solid was suction dried for 45 minutes and finally dried under vacuum of 600 mm Hg at 60° C. for about 3 hours to afford the crystalline monohydrate of zoledronic acid.

1. Zoledronic acid trihydrate.

2. The zoledronic acid trihydrate of claim 1, having an X-ray powder diffraction pattern using Cu Kα radiation substantially in accordance with FIG. 1.

3. The zoledronic acid trihydrate of claim 1, having an X-ray powder diffraction pattern using Cu Kα radiation comprising peaks at about 10.8, 16.4, 17.1, 18.4, 21.6, 24.9, 25.4, 27.8, 31.0, and 32.6, ±0.2 degrees 2θ.

4. The zoledronic acid trihydrate of claim 2, having an X-ray powder diffraction pattern using Cu Kα radiation further comprising peaks at about 38.0, 40.2, 21.8, 9.2, 10.3, and 43.4, ±0.2 degrees 2θ.

5. The zoledronic acid trihydrate of claim 1, having an infrared absorption spectrum substantially in accordance with FIG. 2.

6. The zoledronic acid trihydrate of claim 1, having an infrared absorption spectrum comprising peaks at about 671, 712, 766, 975, 1301, 1323, 1406, 1460, 1550, 2826, 3154, and 3484, ±5 cm⁻¹.

7. The zoledronic acid trihydrate of claim 1, having a differential scanning calorimetry curve substantially in accordance with FIG. 3.

8. The zoledronic acid trihydrate of claim 1, having a differential scanning calorimetry curve comprising an exotherm at about 234° C., and endotherms at about 224° C. and about 88° C.

9. A process for preparing zoledronic acid trihydrate, comprising providing a solution of zoledronic acid in a solvent comprising Water at temperatures of less than about 80° C., and cooling the solution to crystallize zoledronic acid trihydrate.

10. The process of claim 9, wherein a solution of zoledronic acid is at temperatures about 70 to 75° C.

11. The process of claim 9, wherein a solvent comprises water and an organic solvent.

12. A process for converting zoledronic acid trihydrate to zoledronic acid monohydrate, comprising drying zoledronic acid trihydrate at temperatures about 40 to 90° C.

13. A process for converting zoledronic acid trihydrate to zoledronic acid monohydrate, comprising forming a slurry of zoledronic acid trihydrate in a ketone.

14. A process for preparing zoledronic acid monohydrate, comprising providing an aqueous solution of zoledronic acid and adding an antisolvent for zoledronic acid.

15. The process of claim 14, wherein an antisolvent comprises one or more of a hydrocarbon, a ketone, an ether, an ester, and a halogenated hydrocarbon.

16. The process of claim 14, wherein an antisolvent comprises a ketone.

17. Zoledronic acid trihydrate, having single crystal parameters about:

| Parameter Space Group | | |
|---|---|---|
| Cell dimensions | P2₁/c (No. 14) | |
| 1a (Å) | 6.863 | (2) |
| b (Å) | 9.439 | (3) |
| c (Å) | 10.808 | (3) |
| α (Å) | 65.175 | (7) |
| β (Å) | 76.816 | (11) |
| γ (Å) | 81.386 | (13) |
| Volume (Å³) | 617.6 | (3) |
| | |
|---|---|
| Z (Molecules/Unit cell) | 2 |

as determined by X-ray diffraction.
